(19) United States
(12) Patent Application Publication
(10) Pub. No.: US 2022/0064062 A1
(43) Pub. Date: Mar. 3, 2022

(54) GLASS ARTICLES WITH PROTECTIVE FILMS AND METHODS OF FORMING GLASS ARTICLES WITH PROTECTIVE FILMS

(71) Applicant: CORNING INCORPORATED, Corning, NY (US)

(72) Inventors: Jonas Bankaitis, Horseheads, NY (US); Alejandro Antonio Becker, Stockdorf (FR); Bradley Frederick Bowden, Corning, NY (US); Yuvanash Kasinathan, Planegg (IN); Albert Roth Nieber, Painted Post, NY (US); Garrett Andrew Piech, Corning, NY (US); Sergio Tsuda, Horseheads, NY (US); Kristopher Allen Wieland, Painted Post, NY (US)

(21) Appl. No.: 17/412,471

(22) Filed: Aug. 26, 2021

Related U.S. Application Data
(60) Provisional application No. 63/071,117, filed on Aug. 27, 2020.

(51) Int. Cl. C03C 23/00; G11B 5/73; C03C 17/00

(52) U.S. Cl. CPC C03C 23/0025; G11B 5/73921; C03C 2217/70; C03C 2218/328; C03C 2218/365; C03C 17/001

(57) ABSTRACT

Glass articles with protective films used for processing hard disk drive substrates and methods of forming glass articles with protective films used for processing hard disk drive substrates are provided herein. In one embodiment, a glass blank includes: a first surface, a second surface opposing the first surface, and an edge surface connecting the first surface and the second surface; wherein the first surface comprises a first coated portion and a first uncoated portion surrounding the first coated portion, wherein the first uncoated portion extends a first distance radially inward from the edge toward a center of the first surface, wherein the second surface comprises a second coated portion and a second uncoated portion surrounding the second coated portion, wherein the second uncoated portion extends a second distance radially inward from the edge toward a center of the second surface.

### CROSS-REFERENCE TO RELATED APPLICATIONS

This application claims the benefit of priority under 35 U.S.C. § 119 of U.S. Provisional Application Ser. No. 63/071,117 filed on Aug. 27, 2020, the content of which is relied upon and incorporated herein by reference in its entirety.

### FIELD

The present disclosure relates to glass articles with protective films and methods of forming glass articles with protective films, and in particular glass articles with protective films used for processing hard disk drive substrates and methods of forming glass articles with protective films used for processing hard disk drive substrates.

### BACKGROUND

Ready to sputter (RTS) substrates that can be coated with magnetic films to form magnetic recording media (such as hard disk drives) may be formed from processed glass blanks. The glass blanks may undergo processing steps such as packing, shipping, edge grinding, edge chamfering, and edge polishing. During the processing steps listed above, the glass surface may come into contact with other surfaces that can cause damage (e.g. scratches, digs, chips). To address defects in the glass blank produced during the glass blank formation process, the surfaces of the glass blank are polished resulting in material removal from the glass blank. If the depth (including subsurface damage) of such damage exceeds the material removal during the surface polishing the RTS substrate produced may suffer from low strength or defectivity that exceeds the specification for proceeding to the magnetic thin film coating process step.

Accordingly, the inventors have developed improved glass articles with protective films used for forming ready to sputter substrates and methods of forming glass articles with protective films used for forming ready to sputter substrates.

SUMMARY

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

A first embodiment of the present disclosure includes a glass sheet, comprising a first surface, a second surface opposing the first surface, and an edge surface connecting the first surface and the second surface; a first coating forming a plurality of first coated regions disposed atop the first surface, each first coated region separated from an adjacent first coated region by an uncoated region; a second coating forming a plurality of second coated regions disposed atop the second surface, each second coated region separated from an adjacent second coated region by an uncoated region, wherein each of the second coated regions is positioned on the second surface opposite a corresponding first coated region on the first surface.

A second embodiment of the present disclosure may include the first embodiment, wherein the first coating has a thickness of about 10 nm to about 1 mm.

A third embodiment of the present disclosure may include the first and second embodiment, wherein the second coating has a thickness of about 10 nm to about 1 mm.

A fourth embodiment of the present disclosure may include the first to third embodiment, wherein each first coated region comprises an inner radius and an outer radius, wherein the inner radius defines an inner uncoated region.

A fifth embodiment of the present disclosure may include the fourth embodiment, wherein the inner radius of the first coated region is about 15 mm to about 30 mm.

A sixth embodiment of the present disclosure may include the fourth embodiment, wherein the outer radius of the first coated region is about 50 mm to about 100 mm.

A seventh embodiment of the present disclosure may include the first to sixth embodiment, wherein each second coated region comprises an inner radius and an outer radius, wherein the inner radius defines an inner uncoated region.

A eighth embodiment of the present disclosure may include the seventh embodiment, wherein the inner radius of the second coated region is about 15 mm to about 30 mm.

A ninth embodiment of the present disclosure may include the eighth embodiment, wherein the outer radius of the second coated region is about 50 mm to about 100 mm.

A tenth embodiment of the present disclosure includes a glass blank, comprising: a first surface, a second surface opposing the first surface, and an edge surface connecting the first surface and the second surface; wherein the first surface comprises a first coated portion and a first uncoated portion surrounding the first coated portion, wherein the first uncoated portion extends a first distance radially inward from the edge toward a center of the first surface, wherein the second surface comprises a second coated portion and a second uncoated portion surrounding the second coated portion, wherein the second uncoated portion extends a second distance radially inward from the edge toward a center of the second surface.

A eleventh embodiment of the present disclosure may include the tenth embodiment, wherein the first distance is about 100 microns to about 300 microns.

A twelfth embodiment of the present disclosure may include the tenth to eleventh embodiment, wherein second distance is about is about 100 microns to about 300 microns.

A thirteenth embodiment of the present disclosure may include the tenth to twelfth embodiment, wherein a portion of the uncoated portion comprises a chamfered surface.

A fourteenth embodiment of the present disclosure may include the tenth to thirteenth embodiment, wherein a portion of the uncoated portion comprises a polished surface.

A fifteenth embodiment of the present disclosure may include the tenth to fourteenth embodiment, wherein the first coated portion comprises an inner radius and an outer radius, wherein the inner radius defines an inner uncoated region.

A sixteenth embodiment of the present disclosure may include the fifteenth embodiment, wherein the inner radius of the first coated region is about 15 mm to about 30 mm.

A seventeenth embodiment of the present disclosure may include the fifteenth embodiment, wherein the outer radius of the first coated region is about 50 mm to about 100 mm.

A eighteenth embodiment of the present disclosure may include the tenth to seventeenth embodiment, wherein the second coated portion comprises an inner radius and an outer radius, wherein the inner radius defines an inner uncoated region.

A nineteenth embodiment of the present disclosure may include the eighteenth embodiment, wherein the inner radius of the first coated region is about 15 mm to about 30 mm.

A twentieth embodiment of the present disclosure may include the eighteenth embodiment, wherein the outer radius of the first coated region is about 50 mm to about 100 mm.

A twenty-first embodiment of the present disclosure includes a method of producing a glass blank, comprising: cutting a glass sheet via a pulsed laser beam focused into a quasi-non-diffracting beam, wherein the glass sheet comprises a first surface, a second surface opposing the first surface, an edge surface connecting the first surface and the second surface, a first coating disposed on the first surface of the glass sheet, and a second coating disposed on the second surface of the glass sheet, wherein the laser beam is directed into a stack comprising the first coating, the glass sheet, and the second coating, wherein the quasi-non-diffracting beam enters the stack and generates an induced absorption within the stack, wherein the induced absorption produces a damage track defining the glass blank within the first coating at the first surface, the glass sheet, and the second coating at the second surface, wherein the first coating and the second coating is transparent to at least one wavelength of the pulsed laser beam; removing a portion of the first coating from the glass sheet; removing a portion of the second coating from the glass sheet; and separating the coated portion of the glass sheet to form the glass blank from the uncoated portion of the glass sheet.

A twenty-second embodiment of the present disclosure includes a method of producing a glass blank, comprising: directing a pulsed laser beam, focused into a quasi-non-diffracting beam, into a glass sheet, wherein the glass sheet comprises a first surface, a second surface opposing the first surface, an edge surface connecting the first surface and the second surface, a first coating disposed on the first surface of the glass sheet, and a second coating disposed on the second surface of the glass sheet, wherein the quasi-non-diffracting beam generates an induced absorption to produce a first damage track within the first coating; removing a portion of the first coating defined by the first damage track from the first surface; directing the pulsed laser beam, focused into the quasi-non-diffracting beam, into the second coating, wherein the quasi-non-diffracting beam generates an induced absorption to produce a second damage track within the second coating at the second surface; removing a portion of the second coating defined by the second damage track from the second surface; directing the pulsed laser beam, focused into the quasi-non-diffracting beam, into the portion of the glass sheet without the first coating and the second coating, wherein the quasi-non-diffracting beam generates an induced absorption within the glass sheet to produce a third damage track within the glass sheet; and separating the glass blank from the glass sheet.

A twenty-third embodiment of the present disclosure includes a method of producing a glass article, comprising: directing a pulsed laser beam, focused into a quasi-non-diffracting beam, into a glass sheet, wherein the glass sheet comprises a first surface, a second surface opposing the first surface, an edge surface connecting the first surface and the second surface, a first coating disposed on the first surface of the glass sheet, and a second coating disposed on the second surface of the glass sheet , wherein the quasi-non-diffracting beam generates an induced absorption to produce a first damage track within the first coating at the first surface; removing a portion of the first coating defined by the first damage track from the first surface; directing the pulsed laser beam, focused into the quasi-non-diffracting beam, into the portion of the glass sheet without the first coating, wherein the quasi-non-diffracting beam generates an induced absorption within the glass sheet to produce a second damage track within the glass sheet; directing the pulsed laser beam, focused into the quasi-non-diffracting beam, into the second coating, wherein the quasi-non-diffracting beam generates an induced absorption to produce a third damage track within the second coating at the second surface; removing a portion of the second coating defined by the second damage track from the second surface; and separating the glass blank from the glass sheet.

A twenty-fourth embodiment of the present disclosure includes a method of producing a glass article, comprising: directing a pulsed laser beam, focused into a quasi-non-diffracting beam, into a glass sheet, wherein the glass sheet comprises a first surface, a second surface opposing the first surface, an edge surface connecting the first surface and the second surface, a first coating disposed on the first surface of the glass sheet, and a second coating disposed on the second surface of the glass sheet, wherein the quasi-non-diffracting beam generates an induced absorption to produce a first damage track within the first coating at the first surface; removing a portion of the first coating defined by the first damage track from the first surface; directing a pulsed laser beam focused into a quasi-non-diffracting beam into glass sheet, wherein the quasi-non-diffracting beam generates an induced absorption to produce a second damage track within the glass sheet and the second coating; removing a portion of the second coating defined by the second damage track from the second surface; and separating the glass blank from the glass sheet.

A twenty-fourth embodiment of the present disclosure includes a method of cutting a glass article, comprising: directing a laser beam into a first surface of a glass sheet to produce a damage track within the glass sheet, wherein the first surface is a flat surface and wherein the glass sheet further comprises: a second surface opposing the first surface, wherein the second surface is a structured surface, a protective coating disposed on the second surface, the protective coating having a refractive index greater than or equal to a refractive index of the glass sheet; guiding the laser beam over the glass sheet to define the glass article; and separating the glass article from the glass sheet.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a top view of a glass sheet with coated portions in accordance with some embodiments of the present disclosure;

FIG. 2 is a cross-sectional view of a glass sheet of FIG. 1 with coated portions in accordance with some embodiments of the present disclosure;

FIG. 3 is a top view of a glass sheet with coated portions in accordance with some embodiments of the present disclosure;

FIG. 4 is a cross-sectional view of a glass sheet of FIG. 3 with coated portions in accordance with some embodiments of the present disclosure;

FIG. 5 depicts an exemplary glass blank in accordance with some embodiments of the present disclosure;

FIG. 6 depicts a top-view of the exemplary glass blank of FIG. 5 in accordance with some embodiments of the present disclosure;

FIG. 7 is a cross-sectional view of a glass blank of FIG. 6 with coated portions in accordance with some embodiments of the present disclosure;

FIG. 8A depicts an exemplary glass blank in accordance with some embodiments of the present disclosure.

FIG. 8B depicts an exemplary glass blank in accordance with some embodiments of the present disclosure

FIG. 9A depicts a top-view of the exemplary glass blank of FIG. 8A in accordance with some embodiments of the present disclosure.

FIG. 9B depicts a top-view of the exemplary glass blank of FIG. 8B in accordance with some embodiments of the present disclosure.

FIG. 10A is a cross-sectional view of a glass blank of FIG. 8A with coated portions in accordance with some embodiments of the present disclosure.

FIG. 10B is a cross-sectional view of a glass blank of FIG. 8B with coated portions in accordance with some embodiments of the present disclosure

FIG. 11 depicts a flowchart of an exemplary method of cutting a glass blank from a glass sheet, in accordance with some embodiments of the present disclosure.

FIG. 12 depicts an side view of a glass sheet used in the method of FIG. 11 in accordance with some embodiments of the present disclosure;

FIG. 13 depicts an side view of a glass sheet used in the method of FIG. 11 in accordance with some embodiments of the present disclosure;

FIG. 14 depicts a side view of a glass sheet used in the method of FIG. 11 in accordance with some embodiments of the present disclosure;

FIG. 15 depicts a side view of a glass blank formed via the method of FIG. 11 in accordance with some embodiments of the present disclosure;

FIG. 16 depicts a flowchart of an exemplary method of cutting a glass blank from a glass sheet, in accordance with some embodiments of the present disclosure;

FIG. 17 depicts a side view of a glass sheet used in the method of FIG. 16 in accordance with some embodiments of the present disclosure;

FIG. 18 depicts a side view of a glass sheet used in the method of FIG. 16 in accordance with some embodiments of the present disclosure;

FIG. 19 depicts a side view of a glass sheet used in the method of FIG. 16 in accordance with some embodiments of the present disclosure;

FIG. 20 depicts a side view of a glass blank formed via the method of FIG. 16 in accordance with some embodiments of the present disclosure;

FIG. 21 depicts a flowchart of an exemplary method of cutting a glass blank from a glass sheet, in accordance with some embodiments of the present disclosure;

FIG. 22 depicts a side view of a glass sheet used in the method of FIG. 21 in accordance with some embodiments of the present disclosure;

FIG. 23 depicts a side view of a glass sheet used in the method of FIG. 21 in accordance with some embodiments of the present disclosure;

FIG. 24 depicts a side view of a glass sheet used in the method of FIG. 21 in accordance with some embodiments of the present disclosure;

FIG. 25 depicts a side view of a glass sheet used in the method of FIG. 21 in accordance with some embodiments of the present disclosure;

FIG. 26 depicts a side view of a glass blank formed via the method of FIG. 21 in accordance with some embodiments of the present disclosure;

FIG. 27 depicts a flowchart of an exemplary method of cutting a glass blank from a glass sheet, in accordance with some embodiments of the present disclosure;

FIG. 28 depicts a side view of a glass sheet used in the method of FIG. 27 in accordance with some embodiments of the present disclosure;

FIG. 29 depicts a side view of a glass sheet used in the method of FIG. 27 in accordance with some embodiments of the present disclosure;

FIG. 30 depicts a side view of a glass sheet used in the method of FIG. 27 in accordance with some embodiments of the present disclosure;

FIG. 31 depicts a side view of a glass sheet used in the method of FIG. 27 in accordance with some embodiments of the present disclosure;

FIG. 32 depicts a flowchart of an exemplary method 700 of cutting a glass article (e.g. a glass blank) from a glass sheet, in accordance with some embodiments of the present disclosure; and

FIG. 33 depicts a side view of a glass sheet used in the method of FIG. 32 in accordance with some embodiments of the present disclosure.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this detailed description.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

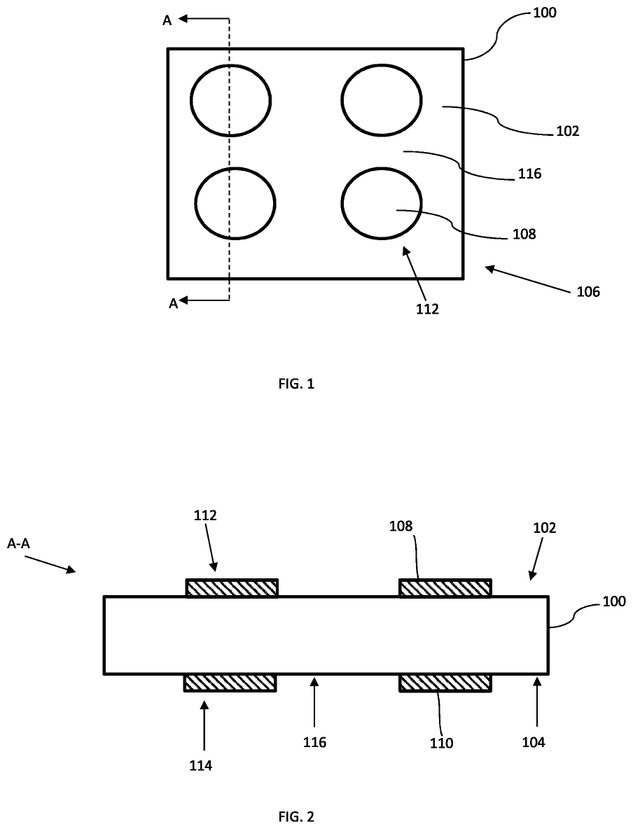

FIG. 1 depicts a top view of a glass sheet with coated portions in accordance with some embodiments of the present disclosure. The glass sheet 100 includes a first surface 102, a second surface 104 opposing the first surface 102, and an edge surface 106 connecting the first surface 102 and the second surface 104. FIG. 2 is a cross-sectional view of the glass sheet 100 of FIG. 1 with coated portions in accordance with some embodiments of the present disclosure. In some embodiments, an exemplary glass sheet may be manufactured via a fusion draw process. U.S. Pat. No. 9,643,875 issued May 9, 2017 to Brunello et. al. describes an exemplary fusion draw apparatus and process, which is incorporated by reference herein, for forming glass sheets. The embodiments of the present disclosure are not limited to glass sheets formed via a fusion draw process, as embodiments described herein are equally applicable to other forming processes such as, but not limited to, slot draw, float, rolling, and other sheet-forming processes known to those skilled in the art.

The glass sheet 100 includes a first coating 108 and a second coating 110. The first coating 108 forms a plurality of first coated regions 112 atop the first surface 102 of the glass sheet 100. The second coating 110 forms a plurality of second coated regions 114 disposed atop the second surface 104. In some embodiments, the first coated region 112 covers the entirety of the first surface 102 and the second coated region 114 covers the entirety of the second surface 104.

In some embodiments, as shown in FIG. 1 and FIG. 2, each of the plurality of first coated regions 112 are separated from other first coated regions 112 by an uncoated region 116 and each second coated region 114 is separated from other second coated regions 114 by an uncoated region 116. Each of the second coated regions 114 is positioned on the second surface 104 opposite a corresponding first coated region 112 on the first surface 102. While FIG. 1 depicts an embodiment having four coated regions, this embodiment is not intended to be limiting and a glass sheet 100 may have more or less coated regions depending on the size of the glass sheet and the size of the coated regions.

In some embodiments, the first coating 108 may have a coating thickness of less than about 1 mm. In some embodiments, the first coating 108 may have a coating thickness of about 10 nm to about 1 mm, or in some embodiments about 10 nm to about 0.5 mm, or in some embodiments about 10 nm to about 0.1 mm, or in some embodiments about 10 nm to about 0.01 mm, or in some embodiments about 10 nm to about 0.001 mm, or in some embodiments about 10 nm to about 0.0001 mm.

In some embodiments, the second coating 110 may have a coating thickness of less than about 1 mm. In some embodiments, the second coating 110 may have a coating thickness of about 10 nm to about 1 mm, or in some embodiments about 10 nm to about 0.5 mm, or in some embodiments about 10 nm to about 0.1 mm, or in some embodiments about 10 nm to about 0.01 mm, or in some embodiments about 10 nm to about 0.001 mm, or in some embodiments about 10 nm to about 0.0001 mm. In some embodiments, the first coating 108 and the second coating 110 may have the same coating thickness. In some embodiments, the first coating 108 and the second coating 110 may have different coating thicknesses.

In some embodiments, the first coating and the second coating may be a polyethylene plastic sheeting (e.g., Visqueen). In some embodiments, the first coating and the second coating may be a dry photoresist material (e.g. DuPont MX500). In some embodiments, the coating may be applied to the surface of the glass sheet by a screen printing. An exemplary screen printing process and apparatus is described in U.S. Patent Publication 20170217151 published Aug. 3, 2017 to Cutcher et. al. The embodiments of the present disclosure are not limited to coatings deposited via a screen printing process, as embodiments described herein are equally applicable to other deposition processes such as, but not limited to, spray coating, dip coating, fog coating, chemical vapor deposition, and other deposition processes known to those skilled in the art.

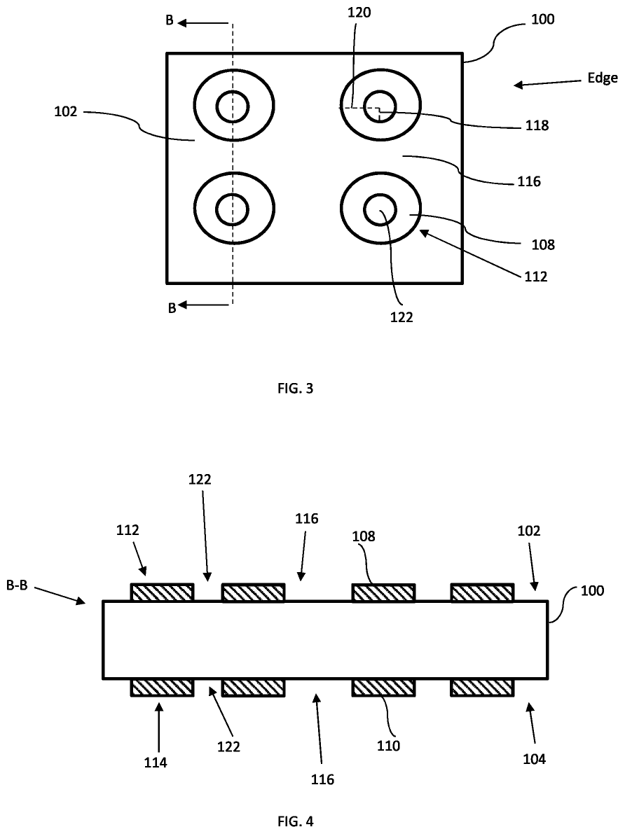

FIG. 3 depicts a top view of another exemplary glass sheet 100 with coated portions in accordance with some embodiments of the present disclosure. FIG. 4 is a cross-sectional view of the glass sheet 100 of FIG. 3 with coated portions in accordance with some embodiments of the present disclosure. As shown in FIG. 3, each coated region comprises an inner radius 118 and an outer radius 120, where the inner radius 118 defines an inner uncoated region 122. In some embodiments, the inner radius of the first coated region and the second coated region is about 15 mm to about 30 mm and the outer radius is about 50 mm to about 100 mm.

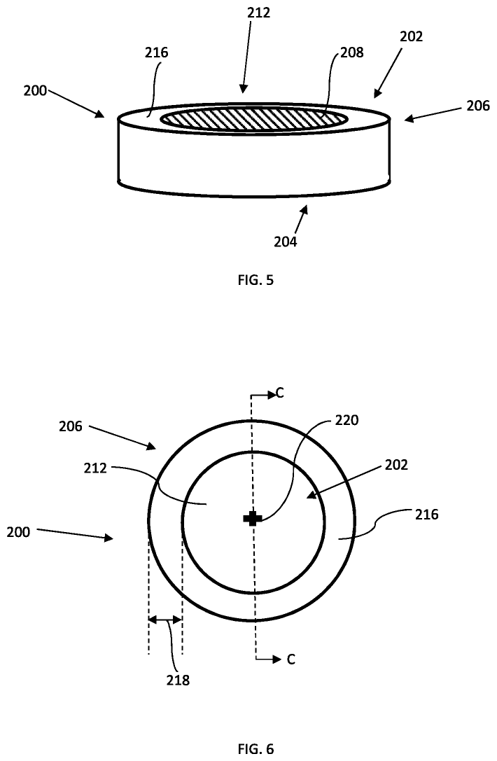

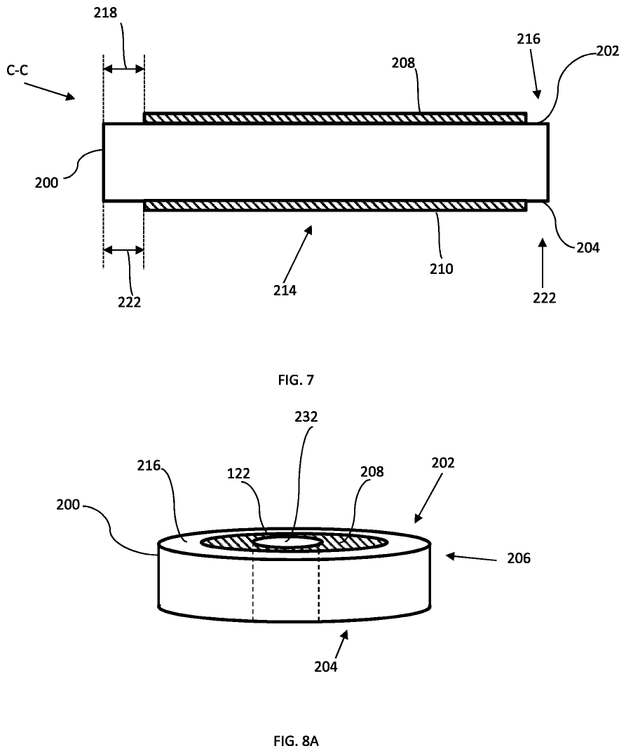

In some embodiments, a portion of the exemplary glass sheet, as described above with respect to any of FIG. 1 to FIG. 4, is cut to form a glass blank suitable for forming ready to sputter (RTS) substrates that can be coated with magnetic films. FIG. 5 depicts an exemplary glass blank in accordance with some embodiments of the present disclosure. The glass blank 200 includes a first surface 202, a second surface 204 opposing the first surface 202, and an edge surface 206 connecting the first surface 202 and the second surface 204. FIG. 6 depicts a top-view of the exemplary glass blank of FIG. 5 in accordance with some embodiments of the present disclosure. FIG. 7 is a cross-sectional view of a glass blank of FIG. 6 with coated portions in accordance with some embodiments of the present disclosure.

The glass blank 200 includes a first coating 208 and a second coating 210. The first coating 208 forms a first coated region 212 atop the first surface 202 of the glass blank 200. The second coating 210 forms a second coated region 214 disposed atop the second surface 204. The second coated region 214 is positioned on the second surface 204 opposite the first coated region 212 on the first surface 202. A first uncoated portion 216 surrounds the first coated region 212 and extends a first distance 218 radially inward from the edge 206 toward a center 220 of the first surface 202. A second uncoated portion 222 surrounds the second coated region 214 and extends a second distance 224 radially inward from the edge 206 toward a center 220 of the second surface 204.

In some embodiments, the first distance 218 is about 100 microns to about 300 microns, or in some embodiments about 125 microns to about 300 microns, or in some embodiments about 150 microns to about 300 microns, or in some embodiments about 175 microns to about 300 microns, or in some embodiments about 200 microns to about 300 microns, or in some embodiments about 225 microns to about 300 microns, or in some embodiments about 250 microns to about 300 microns.

In some embodiments, the second distance 222 is about 100 microns to about 300 microns, or in some embodiments about 125 microns to about 300 microns, or in some embodiments about 150 microns to about 300 microns, or in some embodiments about 175 microns to about 300 microns, or in some embodiments about 200 microns to about 300 microns, or in some embodiments about 225 microns to about 300 microns, or in some embodiments about 250 microns to about 300 microns.

In some embodiments, a portion of the first uncoated region 216 comprises a processed surface. In some embodiments, a portion of the second uncoated region 222 comprises a processed surface. For example, the processed surface can be a chamfered surface or a polished surface. In some embodiments, the uncoated regions 216, 222 may have a chamfer that begins at the edge and extends about 50 microns radially inwards toward the center of the surface, or in some embodiments about 100 microns, or in some embodiments, about 150 microns, or in some embodiments about 200 microns.

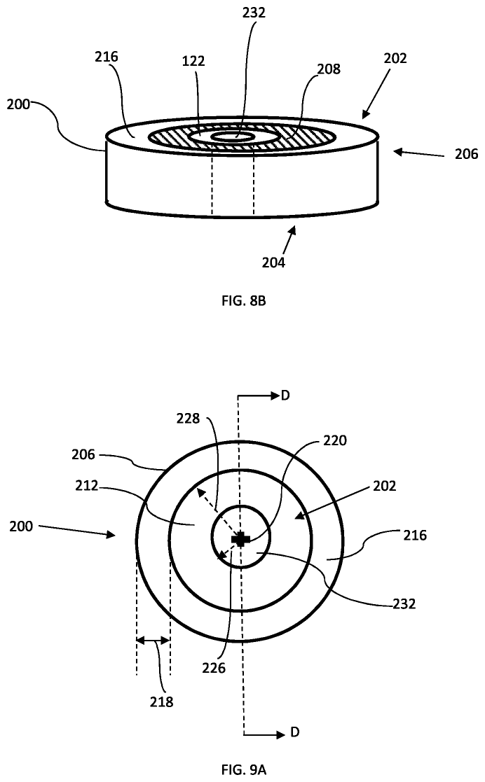

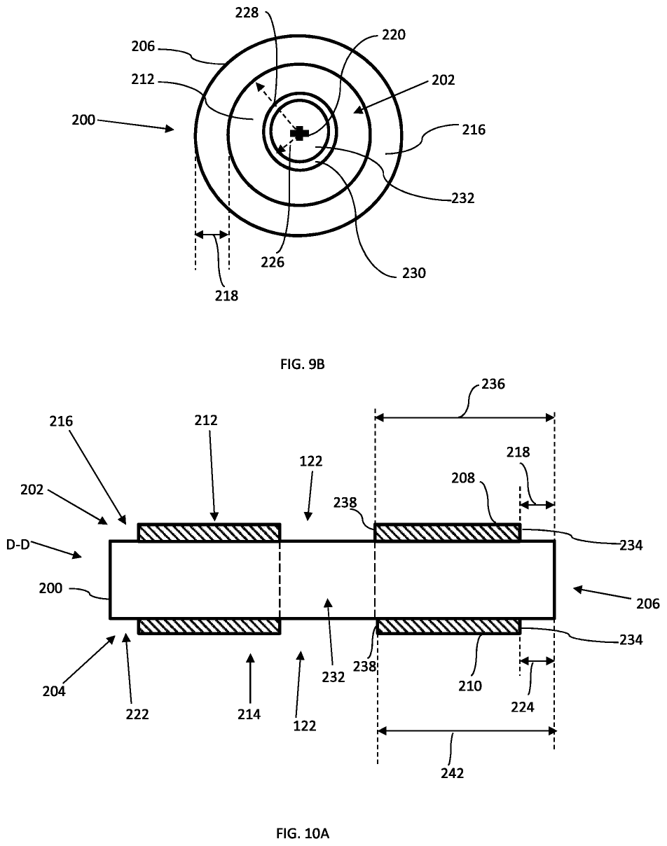

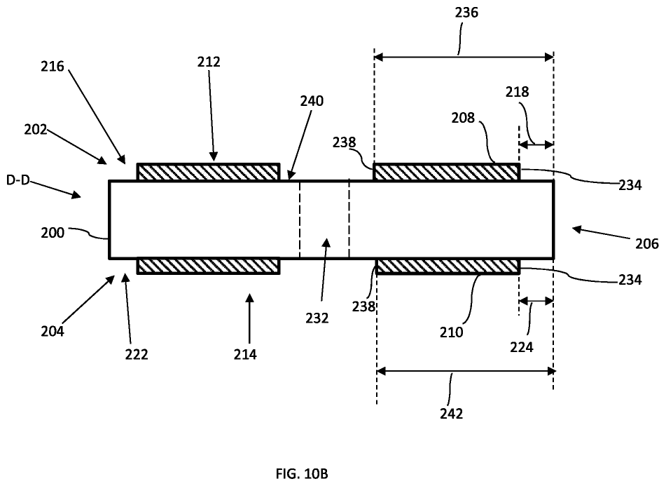

FIG. 8A depicts another exemplary glass blank 200 in accordance with some embodiments of the present disclosure. FIG. 9A depicts a top-view of the exemplary glass blank of FIG. 8A in accordance with some embodiments of the present disclosure. FIG. 10A is a cross-sectional view of a glass sheet of FIG. 8A with coated portions in accordance with some embodiments of the present disclosure.

In some embodiments, the glass blank 200 comprises an central opening 232. As shown in FIG. 9A and FIG. 10A, each coated region 212, 214 comprises an outer edge 234 a distance 218, 224 radially inward from the edge 206 toward a center 220 of the blank 200. Each coated region 212, 214 comprises an inner edge 238 a distance 236, 242 radially inward from the edge 206 toward a center 220 of the blank 200.

In some embodiments, the distance 218, 224 is about 0 mm to about 5 mm. In some embodiments, as depicted in FIG. 8A, FIG. 9A and FIG. 10A, the coated region 212, 214 extends up to the opening 232. In some embodiments, as depicted in FIG. 8B, FIG. 9B and FIG. 10B, the glass blank comprises an inner uncoated region 240 surrounding the opening 232.

The glass blank 200 may be subjected to further processing, including packing, shipping, edge grinding, edge chamfering, and edge polishing, to convert the glass blank into a ready to sputter (RTS) glass substrate suitable for coating with magnetic films for use in magnetic recording media (e.g. hard disk drives). During the processing steps listed above, the glass surface may come into contact with other surfaces that can cause damage (e.g. scratches, digs, chips). To address defects in the glass blank produced during the glass blank formation process, the surfaces of the glass blank are polished resulting in material removal from the glass blank. If the depth (including subsurface damage) of such damage exceeds the material removal during the surface polishing the RTS substrate produced may suffer from low strength or defectivity that exceeds the specification for proceeding to the magnetic thin film coating process step. Embodiments of the glass blanks disclosed herein may advantageously be processed with less surface damage compared to glass blanks produced without a surface coating. Minimizing the surface damage to the glass blank during the processes listed above enables reduced surface removal during subsequent surface polishing steps, thereby reducing costs and improving surface quality.

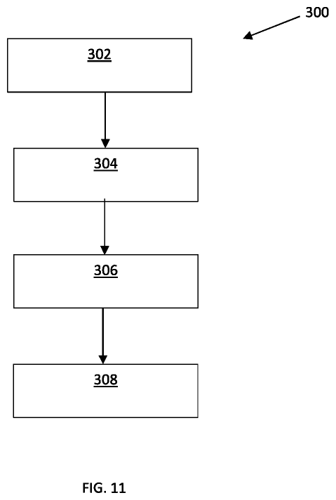

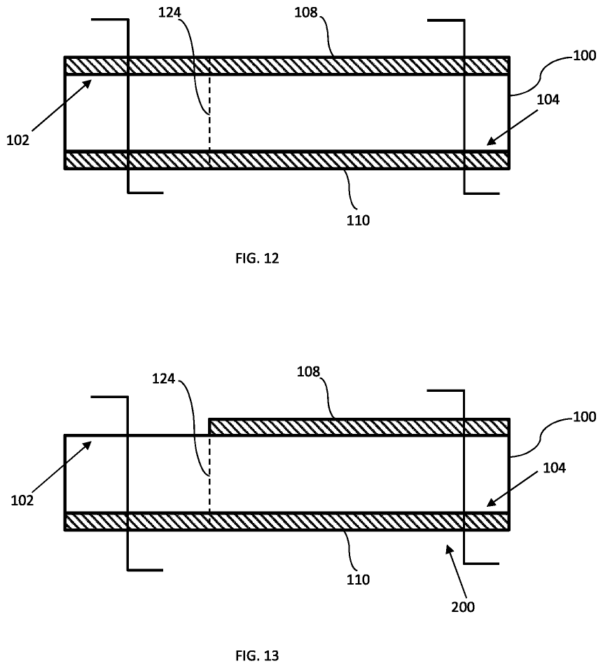

FIG. 11 depicts a flowchart of an exemplary method 300 of cutting a glass blank from a glass sheet, in accordance with some embodiments of the present disclosure. The method 300 is performed on a glass sheet 100 as depicted in FIG. 12. In some embodiments, the glass sheet 100 comprises a first coating 108 on the first surface 102 of the glass sheet, and a second coating 110 on the second surface 104 of the glass sheet. In some embodiments, as depicted in FIG. 12, the first coating 108 covers the entire first surface 102 of the glass sheet 100 and the second coating 110 covers the entire second surface 104 of the glass sheet 100.

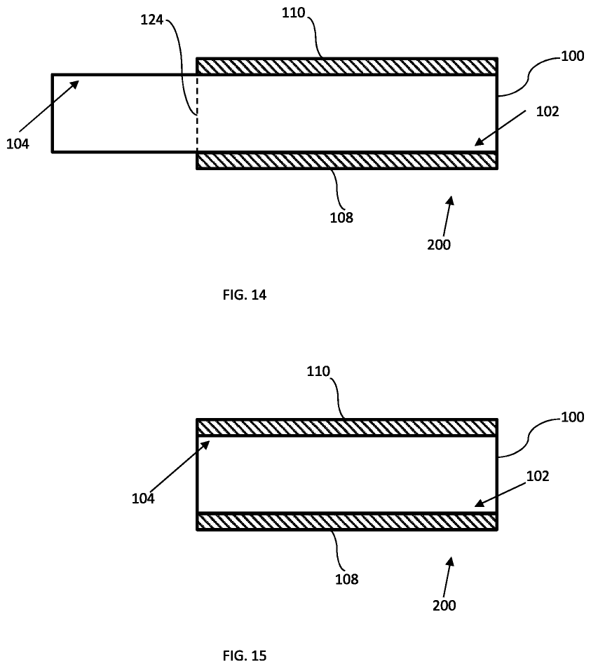

At 302, a pulsed laser beam is focused into a quasi-non-diffracting beam and directed into a stack comprising the first coating 108, the glass sheet 100, and the second coating 110. The quasi-non-diffracting beam enters the stack and generates an induced absorption within the stack producing a damage track 124 defining the glass blank within the first coating, the glass sheet, and the second coating. The first coating 108 and the second coating 110 are transparent to at least one wavelength of the pulsed laser beam. For example, in some embodiments, the first coating 108 and the second coating 110 are transparent to a wavelength of 1064 nm. Alternatively, in some embodiments, the first coating 108 and the second coating 110 are transparent to a wavelength of 532 nm. The damage track 124 may define a glass blank having a circular shape. The embodiments of the present disclosure are not limited to glass blanks having a circular shape, as embodiments described herein are equally applicable to other shapes such as, but not limited to, oval, rectangular, square, or irregular (free form) shapes. Next, at 304 and as depicted in FIG. 13, the first coating 108 is removed from the portion of the glass sheet 100 that is not part of the glass blank 200. The removed portion of the coating (i.e. the portion of the coating not disposed above the part of the glass sheet forming the glass blank) is referred to as herein as “scrap coating”. The glass sheet 100 is then flipped over and, at 306 and as depicted in FIG. 14, the scrap coating portion of the second coating 110 is removed from the portion of the glass sheet 100. At 308, the coated glass blank 200 is separated from the glass sheet.

In some embodiments, the coatings 108, 110 can be removed from the glass sheet via a chemical etching process. In some embodiments, the glass blank 200 can be mechanically separated from the glass sheet 100. FIG. 15 depicts an exemplary glass blank 200 formed via the method 300 having a first coating 108 that covers the entire surface of the first surface 108 and a second coating 110 that covers the entire surface of the second surface 104.

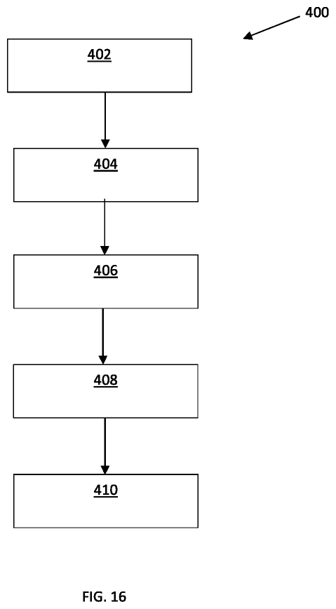

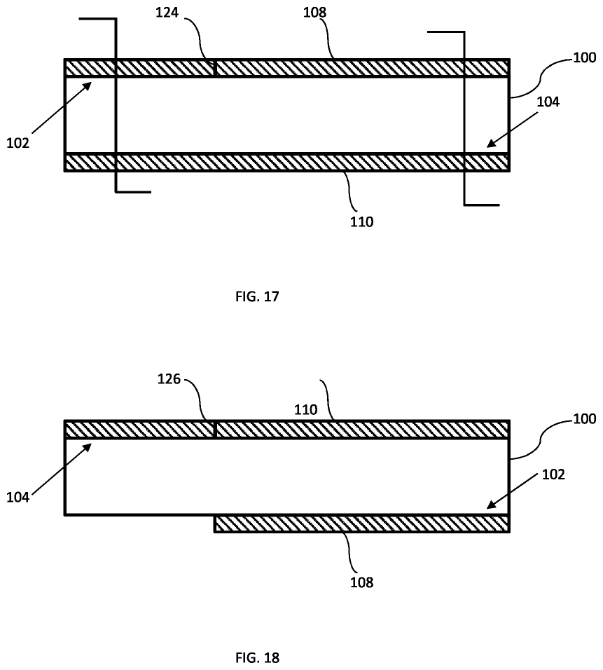

FIG. 16 depicts a flowchart of an exemplary method 400 of cutting a glass blank from a glass sheet, in accordance with some embodiments of the present disclosure. The method 400 is performed on a glass sheet 100 as depicted in FIG. 17. In some embodiments, the glass sheet comprises a first coating 108 on the first surface 102 of the glass sheet 100, and a second coating 110 on the second surface of the glass sheet 100.

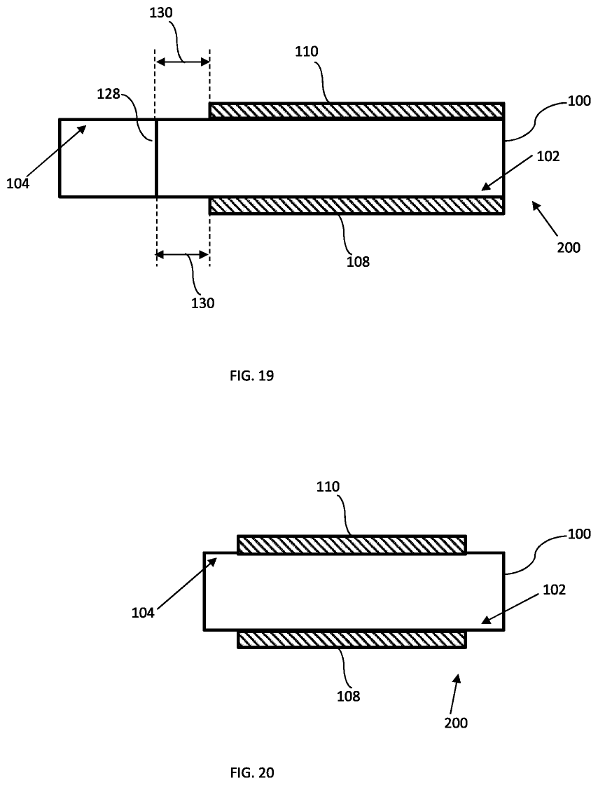

At 402, a pulsed laser beam is focused into a quasi-non-diffracting beam and directed into the first coating 108. The quasi-non-diffracting beam generates an induced absorption to produce a first damage track 124 within the first coating 108. The embodiments of the present disclosure are not limited to quasi-non-diffracting beam to produce a damage track within the coating, other laser beams such as a gaussian beam may be used. At 404, the scrap coating portion of the first coating 108 is removed from the first surface 102. At 406, and as depicted in FIG. 18, the pulsed laser beam is focused into a quasi-non-diffracting beam and directed into the second coating 108. The quasi-non-diffracting beam generates an induced absorption to produce a second damage track 126 within the second coating 110. At 408, the scrap coating portion of the second coating 110 is removed from the second surface 104. At 410, and as depicted in FIG. 19, the pulsed laser beam is focused into a quasi-non-diffracting beam and directed into the uncoated portion of the glass sheet 100. The quasi-non-diffracting beam generates an induced absorption to produce a third damage track 128 within the glass sheet 100. The third damage track 128 is formed a distance 130 away from the coatings 108, 110. The distance 130 is about 100 microns to about 2000 microns, or in some embodiments about 250 microns to about 2000 microns, or in some embodiments about 500 microns to about 2000 microns, or in some embodiments about 1000 microns to about 2000 microns, or in some embodiments about 1250 microns to about 2000 microns, or in some embodiments about 1500 microns to about 2000 microns, or in some embodiments about 1750 microns to about 2000 microns. FIG. 20 depicts an exemplary glass blank 200 formed via the method 400 having a first coating 108 that covers a portion of the first surface 108 and a second coating 110 that covers a portion of the second surface 104.

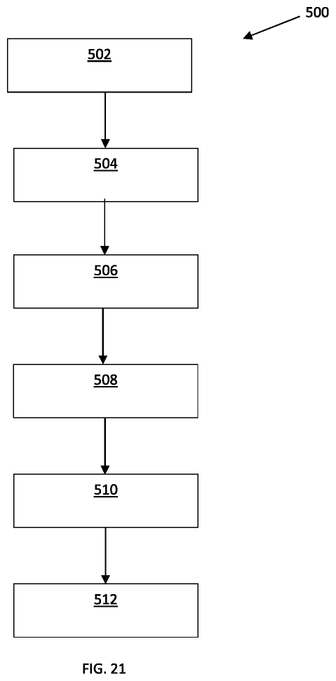

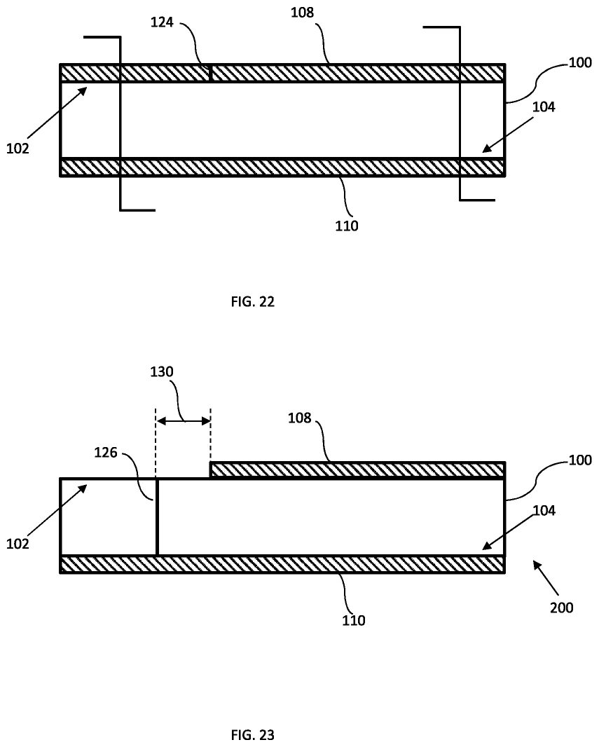

FIG. 21 depicts a flowchart of an exemplary method 500 of cutting a glass blank from a glass sheet, in accordance with some embodiments of the present disclosure. The method 500 is performed on a glass sheet 100 as depicted in FIG. 22. In some embodiments, the glass sheet comprises a first coating 108 on the first surface 102 of the glass sheet 100, and a second coating 110 on the second surface of the glass sheet 100.

At 502, a pulsed laser beam is focused into a quasi-non-diffracting beam and directed into the first coating 108. The quasi-non-diffracting beam generates an induced absorption to produce a first damage track 124 within the first coating 108. At 504, the scrap coating portion of the first coating 108 is removed from the first surface 102.

At 506, and as depicted in FIG. 23, the pulsed laser beam is focused into a quasi-non-diffracting beam and directed into the uncoated portion of the glass sheet 100. The quasi-non-diffracting beam generates an induced absorption to produce a second damage track 126 within the glass sheet 100. The second damage track 126 is formed a distance 130 away from the first coatings 108.

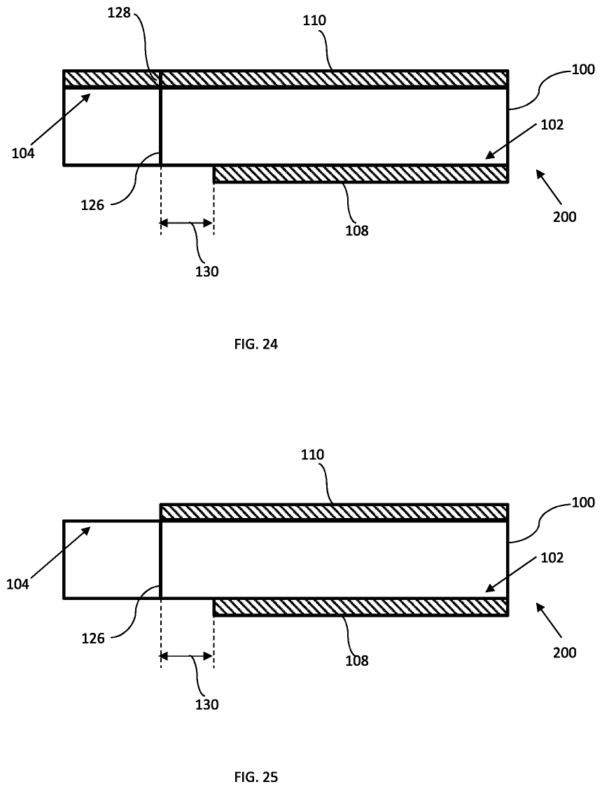

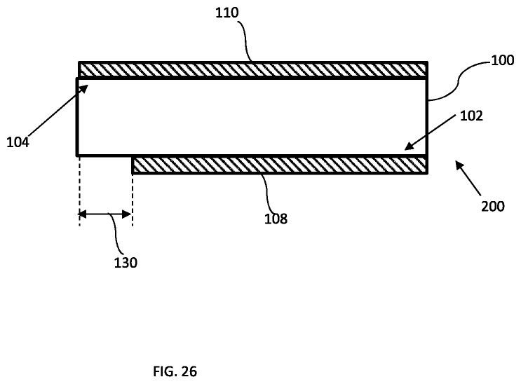

At 508, and as depicted in FIG. 24, the pulsed laser beam is focused into a quasi-non-diffracting beam and directed into the second coating 108. The quasi-non-diffracting beam generates an induced absorption to produce a third damage track 128 within the second coating 110. At 510, and as depicted in FIG. 25, the scrap coating portion of the second coating 110 is removed from the second surface 104. FIG. 26 depicts an exemplary glass blank 200 formed via the method 500.

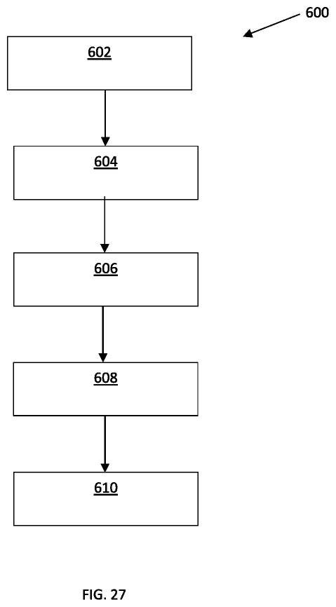

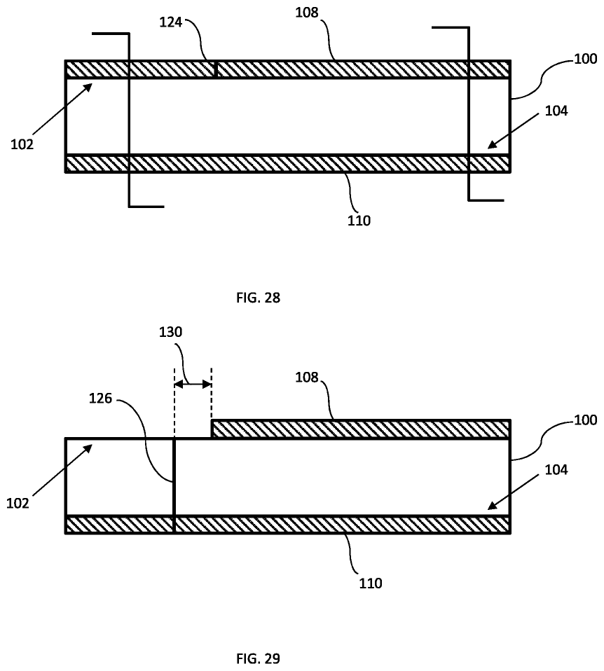

FIG. 27 depicts a flowchart of an exemplary method 600 of cutting a glass blank from a glass sheet, in accordance with some embodiments of the present disclosure. The method 600 is performed on a glass sheet 100 as depicted in FIG. 28. In some embodiments, the glass sheet comprises a first coating 108 on the first surface 102 of the glass sheet 100, and a second coating 110 on the second surface of the glass sheet 100.

At 602, a pulsed laser beam is focused into a quasi-non-diffracting beam and directed into the first coating 108. The quasi-non-diffracting beam generates an induced absorption to produce a first damage track 124 within the first coating 108. At 604, the scrap coating portion of the first coating 108 is removed from the first surface 102.

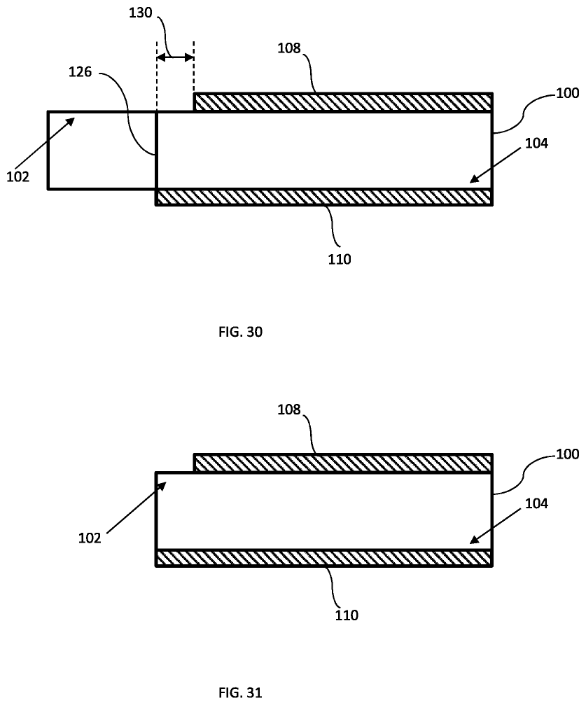

At 606, and as depicted in FIG. 29, the pulsed laser beam is focused into a quasi-non-diffracting beam and directed into the glass sheet 100. The quasi-non-diffracting beam generates an induced absorption to produce a second damage track 126 within the second coating 110 and the glass sheet 100. At 608, and as depicted in FIG. 30, the scrap coating portion of the second coating 110 is removed from the second surface 104. FIG. 31 depicts an exemplary glass blank 200 formed via the method 600.

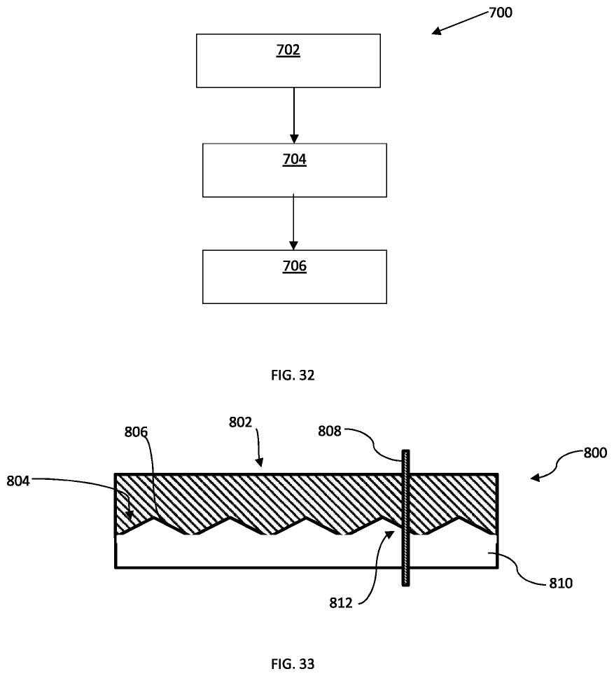

FIG. 32 depicts a flowchart of an exemplary method 700 of cutting a glass article (e.g. a glass blank) from a glass sheet, in accordance with some embodiments of the present disclosure. The method 700 is performed on a glass sheet 800, for example as depicted in FIG. 33, having a first surface 802 and a second surface 804, opposing the first surface 802. In some embodiments, the first surface 802 of the glass sheet 800 is a flat surface (i.e. not a structured surface) and the second surface 804 of the glass sheet is a structured surface. The structured surface 804 comprises a plurality of nano-sized structures 806 having a height and a width situated on the second surface of the glass sheet. The individual nanostructures 806 may be raised, or indented, and may form ridges, dimples, channels, or holes. The individual nanostructures 806 may be, for examples, triangular, rectangular, cylindrical or conical. In some embodiments, the structured surface 804 may be integrally formed on the glass sheet. In some embodiments, the structured surfaces can be formed through PVD or CVD processes directly on the surfaces of the glass sheet. In some embodiments, the structured surfaces can also be etched or even molded into the surface of the glass. In the method 770, at step 702, a laser beam 808 is directed into the first surface 802 of the glass sheet 800 to produce a damage track within the glass sheet. The laser beam 808 is directed orthogonal to the first surface 802. In some embodiments, the laser beam 808 is a pulsed laser beam focused into a quasi-non-diffracting beam and directed into the first surface 802 of the glass sheet 800. The embodiments of the present disclosure are not limited to quasi-non-diffracting beam to produce a damage track, other laser beams such as a gaussian beam may be used. A protective coating 810 is disposed on the structured surface 804. The protective coating 810 is a material that has a refractive index that is greater than or equal to a refractive index of the glass sheet. In some embodiments, the protective coating is a polyethylene plastic sheeting (e.g., Visqueen). The laser path of the laser beam 808 through the glass sheet 800 impacts a first sidewall 812 of the individual nanostructures 806 of the structured surface 804. As the refraction index of the protective coating 810 is equal or higher than the refraction index of the glass sheet 800, the laser beam 808 will not be reflected at the first sidewall 812 into the glass sheet 800. Rather, the path of the laser beam 808 extends in an unmodified direction through the protective coating 810. In contrast, without the protective coating 810 having a refractive index that is greater than or equal to a refractive index of the glass sheet, the laser beam 808 is partially reflected at the of the individual nanostructures 806 back into the material of the glass sheet 800. Thus, a first partial path of the laser beam 808 would extend into the glass sheet 800, causing a modification of the material of the glass sheet 800 and causing a modification of the nanostructures 806 (e.g. an ablation of a part of the nanostructures 806). Furthermore, a second partial path of the laser beam 808 would extends through the nanostructure 806 to crack and/or perforate the glass sheet 800.

At 704, the laser beam is guided over the glass sheet to define the glass article. In some embodiments, the laser beam is held stationary and the glass sheet is rotated to define the glass article. At 706, the glass article is separated from the glass sheet. In some embodiments, the glass article can be mechanically separated from the glass sheet. In some embodiments, the glass sheet can be subjected to a further laser process (e.g. using a CO₂ laser) to crack and separate the glass article from the glass sheet.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

We claim:

1. A glass sheet, comprising
a first surface, a second surface opposing the first surface, and an edge surface connecting the first surface and the second surface;
a first coating forming a plurality of first coated regions disposed atop the first surface, each first coated region separated from an adjacent first coated region by an uncoated region;
a second coating forming a plurality of second coated regions disposed atop the second surface, each second coated region separated from an adjacent second coated region by an uncoated region, wherein each of the second coated regions is positioned on the second surface opposite a corresponding first coated region on the first surface.

2. The glass sheet of claim 1, wherein the first coating has a thickness of about 10 nm to about 1 mm.

3. The glass sheet of claim 1, wherein the second coating has a thickness of about 10 nm to about 1 mm.

4. The glass sheet of claim 1, wherein each first coated region comprises an inner radius and an outer radius, wherein the inner radius defines an inner uncoated region.

5. The glass sheet of claim 4, wherein the inner radius of the first coated region is about 15 mm to about 30 mm.

6. The glass sheet of claim 4, wherein the outer radius of the first coated region is about 50 mm to about 100 mm.

7. The glass sheet of claim 1, wherein each second coated region comprises an inner radius and an outer radius, wherein the inner radius defines an inner uncoated region.

8. The glass sheet of claim 7, wherein the inner radius of the second coated region is about 15 mm to about 30 mm.

9. The glass sheet of claim 7, wherein the outer radius of the second coated region is about 50 mm to about 100 mm.

10. A glass blank, comprising:
a first surface, a second surface opposing the first surface, and an edge surface connecting the first surface and the second surface;
wherein the first surface comprises a first coated portion and a first uncoated portion surrounding the first coated portion, wherein the first uncoated portion extends a first distance radially inward from the edge toward a center of the first surface,
wherein the second surface comprises a second coated portion and a second uncoated portion surrounding the second coated portion, wherein the second uncoated portion extends a second distance radially inward from the edge toward a center of the second surface.

11. The glass blank of claim 10, wherein the first distance is about 100 microns to about 300 microns.

12. The glass blank of claim 10, wherein second distance is about is about 100 microns to about 300 microns.

13. The glass blank of claim 10, wherein a portion of the uncoated portion comprises a chamfered surface.

14. The glass blank of claim 10, wherein a portion of the uncoated portion comprises a polished surface.

15. The glass blank of claim 10, wherein the first coated portion comprises an inner radius and an outer radius, wherein the inner radius defines an inner uncoated region.

16. The glass blank of claim 15, wherein the inner radius of the first coated region is about 15 mm to about 30 mm.

17. The glass sheet of claim 15, wherein the outer radius of the first coated region is about 50 mm to about 100 mm.

18. The glass blank of claim 10, wherein the second coated portion comprises an inner radius and an outer radius, wherein the inner radius defines an inner uncoated region.

19. The glass blank of claim 18, wherein the inner radius of the first coated region is about 15 mm to about 30 mm.

20. The glass blank of claim 18, wherein the outer radius of the first coated region is about 50 mm to about 100 mm.

21. A method of producing a glass blank, comprising:
cutting a glass sheet via a pulsed laser beam focused into a quasi-non-diffracting beam, wherein the glass sheet comprises a first surface, a second surface opposing the first surface, an edge surface connecting the first surface and the second surface, a first coating disposed on the first surface of the glass sheet, and a second coating disposed on the second surface of the glass sheet, wherein the laser beam is directed into a stack comprising the first coating, the glass sheet, and the second coating, wherein the quasi-non-diffracting beam enters the stack and generates an induced absorption within the stack, wherein the induced absorption produces a damage track defining the glass blank within the first coating at the first surface, the glass sheet, and the second coating at the second surface, wherein the first coating and the second coating is transparent to at least one wavelength of the pulsed laser beam;
removing a portion of the first coating from the glass sheet;
removing a portion of the second coating from the glass sheet; and
separating the coated portion of the glass sheet to form the glass blank from the uncoated portion of the glass sheet.

22. A method of producing a glass blank, comprising:
directing a pulsed laser beam, focused into a quasi-non-diffracting beam, into a glass sheet, wherein the glass sheet comprises a first surface, a second surface opposing the first surface, an edge surface connecting the first surface and the second surface, a first coating disposed on the first surface of the glass sheet, and a second coating disposed on the second surface of the glass sheet, wherein the quasi-non-diffracting beam generates an induced absorption to produce a first damage track within the first coating;
removing a portion of the first coating defined by the first damage track from the first surface;
directing the pulsed laser beam, focused into the quasi-non-diffracting beam, into the second coating, wherein the quasi-non-diffracting beam generates an induced absorption to produce a second damage track within the second coating at the second surface;
removing a portion of the second coating defined by the second damage track from the second surface;
directing the pulsed laser beam, focused into the quasi-non-diffracting beam, into the portion of the glass sheet without the first coating and the second coating, wherein the quasi-non-diffracting beam generates an induced absorption within the glass sheet to produce a third damage track within the glass sheet; and
separating the glass blank from the glass sheet.

23. A method of producing a glass article, comprising:
directing a pulsed laser beam, focused into a quasi-non-diffracting beam, into a glass sheet, wherein the glass sheet comprises a first surface, a second surface opposing the first surface, an edge surface connecting the first surface and the second surface, a first coating disposed on the first surface of the glass sheet, and a second coating disposed on the second surface of the glass sheet , wherein the quasi-non-diffracting beam generates an induced absorption to produce a first damage track within the first coating at the first surface;
removing a portion of the first coating defined by the first damage track from the first surface;
directing the pulsed laser beam, focused into the quasi-non-diffracting beam, into the portion of the glass sheet without the first coating, wherein the quasi-non-diffracting beam generates an induced absorption within the glass sheet to produce a second damage track within the glass sheet;
directing the pulsed laser beam, focused into the quasi-non-diffracting beam, into the second coating, wherein the quasi-non-diffracting beam generates an induced absorption to produce a third damage track within the second coating at the second surface;
removing a portion of the second coating defined by the second damage track from the second surface; and
separating the glass blank from the glass sheet.

24. A method of producing a glass article, comprising:
directing a pulsed laser beam, focused into a quasi-non-diffracting beam, into a glass sheet, wherein the glass sheet comprises a first surface, a second surface opposing the first surface, an edge surface connecting the first surface and the second surface, a first coating disposed on the first surface of the glass sheet, and a second coating disposed on the second surface of the glass sheet, wherein the quasi-non-diffracting beam generates an induced absorption to produce a first damage track within the first coating at the first surface;
removing a portion of the first coating defined by the first damage track from the first surface;
directing a pulsed laser beam focused into a quasi-non-diffracting beam into glass sheet, wherein the quasi-non-diffracting beam generates an induced absorption to produce a second damage track within the glass sheet and the second coating;
removing a portion of the second coating defined by the second damage track from the second surface; and
separating the glass blank from the glass sheet.

25. A method of cutting a glass article, comprising:
directing a laser beam into a first surface of a glass sheet to produce a damage track within the glass sheet, wherein the first surface is a flat surface and wherein the glass sheet further comprises: a second surface opposing the first surface, wherein the second surface is a structured surface, a protective coating disposed on the second surface, the protective coating having a refractive index greater than or equal to a refractive index of the glass sheet;
guiding the laser beam over the glass sheet to define the glass article; and
separating the glass article from the glass sheet.
